(19) United States
(12) Patent Application Publication
(10) Pub. No.: US 2026/0051970 A1
(43) Pub. Date: Feb. 19, 2026

(54) Real-Time History-Based Compression for Unreliable Network Connections

(71) Applicant: Citrix Systems, Inc., Fort Lauderdale, FL (US)

(72) Inventor: Muhammad Dawood, Gerrards Cross (GB)

(21) Appl. No.: 18/804,279

(22) Filed: Aug. 14, 2024

(51) Int. Cl. H04L 1/00; H04L 41/0659

(52) U.S. Cl. CPC H04L 1/0014; H04L 41/0661

(57) ABSTRACT

Methods and systems for packet transfers are described. A computing system may initialize first and second instances of an encoder, configured to encode packets for transmission to packet recipient devices. The computing system may encode, using the first instance of the encoder, a packet. The computing system may store, using a packet reference list, a reference to the packet. The computing system may transmit, to a packet recipient device, the encoded packet. The computing system may receive, from the packet recipient device, an acknowledgement list indicating the packet. Based on identifying that the acknowledgement list matches the packet reference list, the computing system may: update a state of the second instance of the encoder based on the packet reference list, update a state of the first instance of the encoder to match a state of the second instance of the encoder, and activate the second instance of the encoder.

### FIELD

Aspects described herein generally relate to computer networking, remote computer access, virtualization, enterprise data management, and hardware and software related thereto. More specifically, one or more aspects described herein improve packet compression for unreliable network connections using real-time history.

### BACKGROUND

In some instances, packets may be compressed prior to transmission using a compression scheme. In some instances, this compression scheme may depend on having a reliable network connection between a client and server. That is, every packet transmitted between the server and client (in either direction) is guaranteed to arrive at the receiver, in the order in which is was sent. This may ensure that the compression state at the receiver mirrors that of the sender, and thus packets may be correctly decompressed without a single bit of information being corrupted.

In some instances, it may be beneficial to use an unreliable connection to transmit data, particularly if guaranteed delivery and ordering semantics are not required. This may allow the application to optimize retransmission of the data as needed. However, if the compression scheme was used to compress a packet which was subsequently lost in transmission, the compression state at the receiver might not reflect that of the sender's, and any future attempts at decompression may result in corrupted data.

### SUMMARY

The following presents a simplified summary of various aspects described herein. This summary is not an extensive overview, and is not intended to identify required or critical elements or to delineate the scope of the claims. The following summary merely presents some concepts in a simplified form as an introductory prelude to the more detailed description provided below.

To overcome limitations in the prior art described above, and to overcome other limitations that will be apparent upon reading and understanding the present specification, aspects described herein are directed towards real-time history based compression for unreliable network connections.

According to one or more illustrative embodiments described herein, a computing system comprising one or more processors, and memory storing computer-executable instructions may initialize a first instance of an encoder and a second instance of the encoder, where the first instance of the encoder and the second instance of the encoder may be configured to encode packets for transmission to packet recipient devices. The computing system may encode, using the first instance of the encoder, a first packet. The computing system may store, using a packet reference list, a reference to the first packet. The computing system may transmit, to a first packet recipient device, the first encoded packet. The computing system may receive, from the first packet recipient device, an acknowledgement list indicating the first packet. Based on identifying that the acknowledgement list matches the packet reference list, the computing system may update a state of the second instance of the encoder based on the packet reference list, clear the packet reference list, update a state of the first instance of the encoder to match a state of the second instance of the encoder, and switch from use of the first instance of the encoder to the second instance of the encoder.

In one or more instances, the first instance of the encoder may correspond to a first compression scheme and the second instance of the encoder may correspond to a second compression scheme. The first packet recipient device may be configured with a first instance of an expander and a second instance of the expander. The first instance of the expander corresponds to the first compression scheme and the second instance of the expander may correspond to the second compression scheme.

In one or more examples, transmitting the first encoded packet further includes transmitting a single bit indicating that the first compression scheme is in use. In one or more examples, the first packet recipient device may decode, based on the single bit indicating that the first compression scheme is in use, the first encoded packet using the first instance of the expander.

In one or more instances, the first packet recipient device may update a state of the second instance of the expander, and record the update to the state of the second instance of the expander in the acknowledgement list with a positive indicator bit indicating that the first encoded packet was used to update the state of the second instance of the expander at the first packet recipient device. In one or more instances, transmitting the first encoded packet may include transmitting, without updating the state of the first instance of the encoder.

In one or more examples, a connection between the packet sender device and the first packet recipient device comprises an unreliable network connection. In one or more examples, the transmission of the first encoded packet to the first packet recipient device fails due to the unreliable network connection.

In one or more instances, the computing system may identify, based on the acknowledgement list, any encoded packets for which transmission failed. In one or more instances, subsequent packets may be encoded using the second instance of the encoder rather than the first instance of the encoder.

In one or more examples, a first subsequent packet may be sent to the first packet recipient device along with an identifier bit that causes the second instance of the expander to activate, rather than the first instance of the expander. In one or more examples, based on activation of the second instance of the expander, the first packet recipient device may update a state of the second instance of the expander based on a state of the first instance of the expander. In one or more examples, updating the state of the second instance of the encoder based on the packet reference list may be based on detection of an indicator bit, included in the packet reference list, indicating an instruction from the first packet recipient device to update the state of the second instance of the encoder.

These and additional aspects will be appreciated with the benefit of the disclosures discussed in further detail below.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1 depicts an illustrative computer system architecture that may be used in accordance with one or more illustrative aspects described herein.

FIG. 2 depicts an illustrative remote-access system architecture that may be used in accordance with one or more illustrative aspects described herein.

FIG. 3 depicts an illustrative virtualized system architecture that may be used in accordance with one or more illustrative aspects described herein.

FIG. 4 depicts an illustrative cloud-based system architecture that may be used in accordance with one or more illustrative aspects described herein.

FIGS. 5A-5B depict an illustrative computing environment for performing real-time history based compression for unreliable network connections in accordance with one or more illustrative aspects described herein.

FIGS. 6A-6B depict an illustrative event sequence for performing real-time history based compression for unreliable network connections in accordance with one or more illustrative aspects described herein.

FIGS. 7-8 depict an illustrative methods for performing real-time history based compression for unreliable network connections in accordance with one or more illustrative aspects described herein.

FIGS. 9-22 depict illustrative charts for performing real-time history based compression for unreliable network connections in accordance with one or more illustrative aspects described herein.

### DETAILED DESCRIPTION

In the following description of the various embodiments, reference is made to the accompanying drawings identified above and which form a part hereof, and in which is shown by way of illustration various embodiments in which aspects described herein may be practiced. It is to be understood that other embodiments may be utilized and structural and functional modifications may be made without departing from the scope described herein. Various aspects are capable of other embodiments and of being practiced or being carried out in various different ways.

As a general introduction to the subject matter described in more detail below, aspects described herein are directed towards real-time history based compression for unreliable network connections. For example, using current methods, where an unreliable connection is being used, a compression scheme may be disabled and any data transmitted between the sender and receiver might not be compressed, which may result in higher than normal bandwidth usage.

Accordingly, described herein is a scheme to allow an unreliable connection to benefit from history-based compression, even when packet loss is present. Broadly speaking, data may be compressed in the following manner. First, an encoder may attempt to find a previous occurrence of the data (or part of the data) in its history buffer, also known as a “match.”

If a match is found, the length of the match may be encoded using an efficient variable-length integer coding scheme. Unlike other LZ-based compression schemes, the position of the match within the history buffer need not be encoded, thereby improving the overall compression efficiency. The sender's compression state may be updated to reflect the most recent occurrence of the match, and the data may be copied to the front of the sender's history buffer.

If a match is not found, the new data may be encoded using an entropy encoding scheme such as Huffman coding, and the sender's compression state may be updated to reflect the location of the new data. This may include the frequencies of the new bytes being encoded as entropy coders may generate smaller encodings for more frequently occurring symbols.

In the case of a match, the new data may be copied to the front of the sender's history buffer. The system described herein describes a process for decoupling the process of locating a match and updating compression and coding states, and thus performing independent encode and decode operations. This may allow for use of the compression scheme despite an unreliable network connection.

For example, encoding may be performed as a first step, where a packet sender attempts to locate a match for new data against a current compression state or, if a match is not found, encodes the new data using an entropy coding scheme such as Huffman coding. In either instance, an encoding may be produced and sent to a receiver. As a second step, compression, coding, and history buffer states may be updated with new data, but might not output any encoding.

In contrast to the reliable implementation, compressing new data might not automatically update the reducer's history buffer and compression state with that new data, but instead may simply locate any previous occurrences of the data within the current contents of the history buffer. The history buffer and compression state might only be updated when the update step is performed. Consequently, updating the history buffer and compression state may become optional, although the fewer updates that are performed, the less likely a match may be located for new data.

Taking this to the extreme, consider the case where a compression scheme is used for encoding, but its state is never updated. The compression efficiency may be poor due to the lack of previously seen data, however, it may be possible to use this primitive compression scheme over an unreliable network connection.

Assume, for example, that a sender sends data packets 1, 2, and 3 to a receiver. Initially, the packets may just be encoded and not used to update a compression state at the sender. As a result, compression may simply amount to packetized entropy coding and the compressed packets may be sent to the receiver.

The receiver may receive and decode the encoded packets sequentially and find that none of them may contain commands that reference previous occurrences of the data within the recipient empty history buffer. Consequently, the only operation performed may be entropy decoding using the same method as was used by the sender to code the data, and the original data may be reconstructed at the receiver's side. As with the sender, the recipient might not update its compression state or history buffer after each packet with the newly decompressed data, and the sender/receiver compression scheme states may remain identical at every step of the way.

Consider, however, if packet 2 was not received by the receiver. The receiver may still successfully decode packet 3 as its compression scheme state might not have been modified after decoding packet 1. In contrast, if the original algorithm was being used (combined encode and update), the recipient may fail to decode packet 3, as the sender may have updated its state with packets 1 and 2, whereas the recipient might not have updated its state with packet 2.

Thus, it may be possible to use this modified compression scheme over an unreliable network connection, but the compression state and history buffer may remain empty.

To address this, described herein is a method to use a modified compression scheme over an unreliable network connection, but with the benefit of compression state and historical data, which provides performance close to a compression scheme operating on a reliable network connection. To do this, a hot swap may be performed between sets of compression scheme states at both the sender and recipient at precise points in time, as is described further below.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “mounted,” “connected,” “coupled,” “positioned,” “engaged” and similar terms, is meant to include both direct and indirect mounting, connecting, coupling, positioning and engaging.

### Computing Architecture

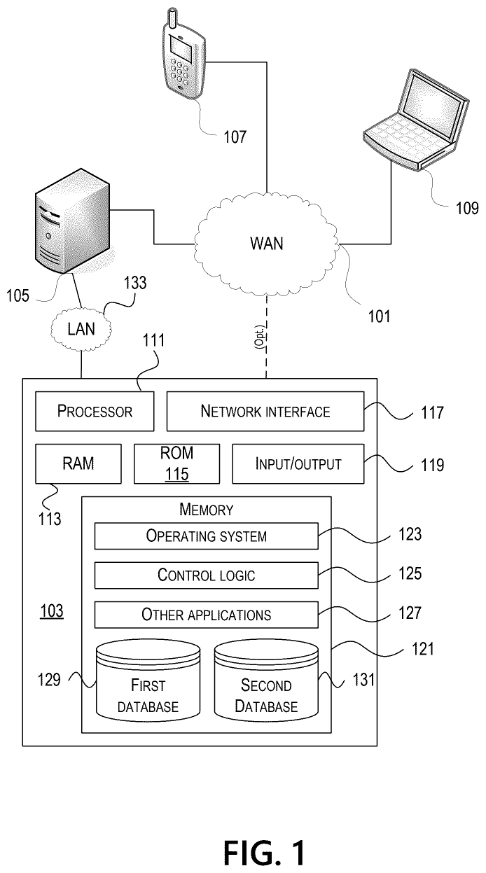

Computer software, hardware, and networks may be utilized in a variety of different system environments, including standalone, networked, remote-access (also known as remote desktop), virtualized, and/or cloud-based environments, among others. FIG. 1 illustrates one example of a system architecture and data processing device that may be used to implement one or more illustrative aspects described herein in a standalone and/or networked environment. Various network nodes 103, 105, 107, and 109 may be interconnected via a wide area network (WAN) 101, such as the Internet. Other networks may also or alternatively be used, including private intranets, corporate networks, local area networks (LAN), metropolitan area networks (MAN), wireless networks, personal networks (PAN), and the like. Network 101 is for illustration purposes and may be replaced with fewer or additional computer networks. A local area network 133 may have one or more of any known LAN topology and may use one or more of a variety of different protocols, such as Ethernet. Devices 103, 105, 107, and 109 and other devices (not shown) may be connected to one or more of the networks via twisted pair wires, coaxial cable, fiber optics, radio waves, or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data-attributable to a single entity-which resides across all physical networks.

The components may include data server 103, web server 105, and client computers 107, 109. Data server 103 provides overall access, control and administration of databases and control software for performing one or more illustrative aspects describe herein. Data server 103 may be connected to web server 105 through which users interact with and obtain data as requested. Alternatively, data server 103 may act as a web server itself and be directly connected to the Internet. Data server 103 may be connected to web server 105 through the local area network 133, the wide area network 101 (e.g., the Internet), via direct or indirect connection, or via some other network. Users may interact with the data server 103 using remote computers 107, 109, e.g., using a web browser to connect to the data server 103 via one or more externally exposed web sites hosted by web server 105. Client computers 107, 109 may be used in concert with data server 103 to access data stored therein, or may be used for other purposes. For example, from client device 107 a user may access web server 105 using an Internet browser, as is known in the art, or by executing a software application that communicates with web server 105 and/or data server 103 over a computer network (such as the Internet).

Servers and applications may be combined on the same physical machines, and retain separate virtual or logical addresses, or may reside on separate physical machines. FIG. 1 illustrates just one example of a network architecture that may be used, and those of skill in the art will appreciate that the specific network architecture and data processing devices used may vary, and are secondary to the functionality that they provide, as further described herein. For example, services provided by web server 105 and data server 103 may be combined on a single server.

Each component 103, 105, 107, 109 may be any type of known computer, server, or data processing device. Data server 103, e.g., may include a processor 111 controlling overall operation of the data server 103. Data server 103 may further include random access memory (RAM) 113, read only memory (ROM) 115, network interface 117, input/output interfaces 119 (e.g., keyboard, mouse, display, printer, etc.), and memory 121. Input/output (I/O) 119 may include a variety of interface units and drives for reading, writing, displaying, and/or printing data or files. Memory 121 may further store operating system software 123 for controlling overall operation of the data processing device 103, control logic 125 for instructing data server 103 to perform aspects described herein, and other application software 127 providing secondary, support, and/or other functionality which may or might not be used in conjunction with aspects described herein. The control logic 125 may also be referred to herein as the data server software 125. Functionality of the data server software 125 may refer to operations or decisions made automatically based on rules coded into the control logic 125, made manually by a user providing input into the system, and/or a combination of automatic processing based on user input (e.g., queries, data updates, etc.).

Memory 121 may also store data used in performance of one or more aspects described herein, including a first database 129 and a second database 131. In some embodiments, the first database 129 may include the second database 131 (e.g., as a separate table, report, etc.). That is, the information can be stored in a single database, or separated into different logical, virtual, or physical databases, depending on system design. Devices 105, 107, and 109 may have similar or different architecture as described with respect to device 103. Those of skill in the art will appreciate that the functionality of data processing device 103 (or device 105, 107, or 109) as described herein may be spread across multiple data processing devices, for example, to distribute processing load across multiple computers, to segregate transactions based on geographic location, user access level, quality of service (QOS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HyperText Markup Language (HTML) or Extensible Markup Language (XML). The computer executable instructions may be stored on a computer readable medium such as a nonvolatile storage device. Any suitable computer readable storage media may be utilized, including hard disks, CD-ROMs, optical storage devices, magnetic storage devices, solid state storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). Various aspects described herein may be embodied as a method, a data processing system, or a computer program product. Therefore, various functionalities may be embodied in whole or in part in software, firmware, and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

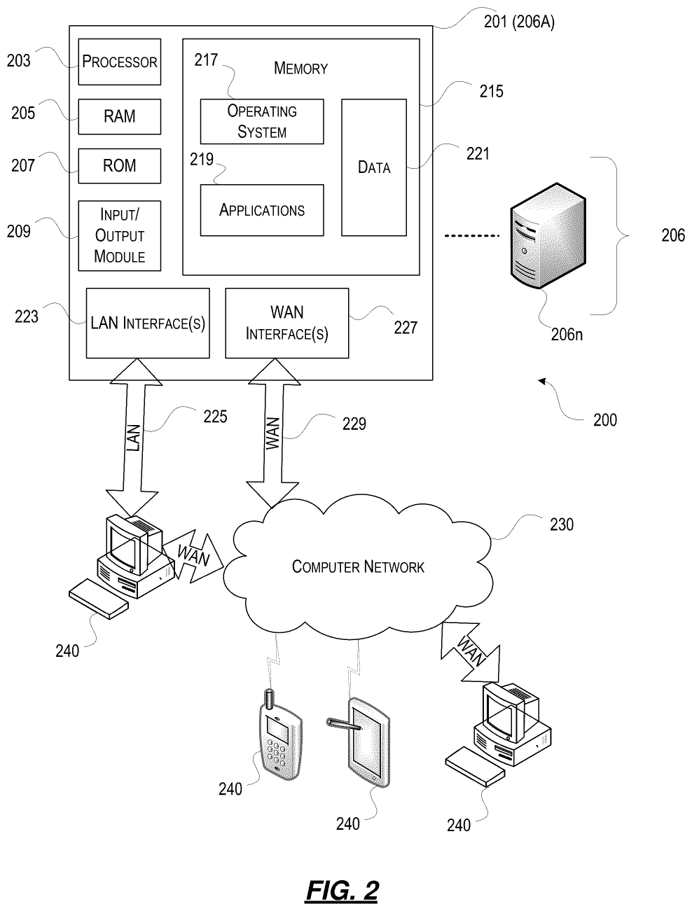

With further reference to FIG. 2, one or more aspects described herein may be implemented in a remote-access environment. FIG. 2 depicts an example system architecture including a computing device 201 in an illustrative computing environment 200 that may be used according to one or more illustrative aspects described herein. Computing device 201 may be used as a server 206a in a single-server or multi-server desktop virtualization system (e.g., a remote access or cloud system) and can be configured to provide virtual machines for client access devices. The computing device 201 may have a processor 203 for controlling overall operation of the device 201 and its associated components, including RAM 205, ROM 207, Input/Output (I/O) module 209, and memory 215.

I/O module 209 may include a mouse, keypad, touch screen, scanner, optical reader, and/or stylus (or other input device(s)) through which a user of computing device 201 may provide input, and may also include one or more of a speaker for providing audio output and one or more of a video display device for providing textual, audiovisual, and/or graphical output. Software may be stored within memory 215 and/or other storage to provide instructions to processor 203 for configuring computing device 201 into a special purpose computing device in order to perform various functions as described herein. For example, memory 215 may store software used by the computing device 201, such as an operating system 217, application programs 219, and an associated database 221.

Computing device 201 may operate in a networked environment supporting connections to one or more remote computers, such as terminals 240 (also referred to as client devices and/or client machines). The terminals 240 may be personal computers, mobile devices, laptop computers, tablets, or servers that include many or all of the elements described above with respect to the computing device 103 or 201.

The network connections depicted in FIG. 2 include a local area network (LAN) 225 and a wide area network (WAN) 229, but may also include other networks. When used in a LAN networking environment, computing device 201 may be connected to the LAN 225 through a network interface or adapter 223. When used in a WAN networking environment, computing device 201 may include a modem or other wide area network interface 227 for establishing communications over the WAN 229, such as computer network 230 (e.g., the Internet). It will be appreciated that the network connections shown are illustrative and other means of establishing a communications link between the computers may be used. Computing device 201 and/or terminals 240 may also be mobile terminals (e.g., mobile phones, smartphones, personal digital assistants (PDAs), notebooks, etc.) including various other components, such as a battery, speaker, and antennas (not shown).

Aspects described herein may also be operational with numerous other general purpose or special purpose computing system environments or configurations. Examples of other computing systems, environments, and/or configurations that may be suitable for use with aspects described herein include, but are not limited to, personal computers, server computers, hand-held or laptop devices, multiprocessor systems, microprocessor-based systems, set top boxes, programmable consumer electronics, network personal computers (PCs), minicomputers, mainframe computers, distributed computing environments that include any of the above systems or devices, and the like.

As shown in FIG. 2, one or more client devices 240 may be in communication with one or more servers 206a-206n (generally referred to herein as “server(s) 206”). In one embodiment, the computing environment 200 may include a network appliance installed between the server(s) 206 and client machine(s) 240. The network appliance may manage client/server connections, and in some cases can load balance client connections amongst a plurality of backend servers 206.

The client machine(s) 240 may in some embodiments be referred to as a single client machine 240 or a single group of client machines 240, while server(s) 206 may be referred to as a single server 206 or a single group of servers 206. In one embodiment a single client machine 240 communicates with more than one server 206, while in another embodiment a single server 206 communicates with more than one client machine 240. In yet another embodiment, a single client machine 240 communicates with a single server 206.

A client machine 240 can, in some embodiments, be referenced by any one of the following non-exhaustive terms: client machine(s); client(s); client computer(s); client device(s); client computing device(s); local machine; remote machine; client node(s); endpoint(s); or endpoint node(s). The server 206, in some embodiments, may be referenced by any one of the following non-exhaustive terms: server(s), local machine; remote machine; server farm(s), or host computing device(s).

In one embodiment, the client machine 240 may be a virtual machine. The virtual machine may be any virtual machine, while in some embodiments the virtual machine may be any virtual machine managed by a Type 1 or Type 2 hypervisor, for example, a hypervisor developed by Citrix Systems, IBM, VMware, or any other hypervisor. In some aspects, the virtual machine may be managed by a hypervisor, while in other aspects the virtual machine may be managed by a hypervisor executing on a server 206 or a hypervisor executing on a client 240.

Some embodiments include a client device 240 that displays application output generated by an application remotely executing on a server 206 or other remotely located machine. In these embodiments, the client device 240 may execute a virtual machine receiver program or application to display the output in an application window, a browser, or other output window. In one example, the application is a desktop, while in other examples the application is an application that generates or presents a desktop. A desktop may include a graphical shell providing a user interface for an instance of an operating system in which local and/or remote applications can be integrated. Applications, as used herein, are programs that execute after an instance of an operating system (and, optionally, also the desktop) has been loaded.

A remote computing environment may include more than one server 206a-206n such that the servers 206a-206n are logically grouped together into a server farm 206, for example, in a cloud computing environment. The server farm 206 may include servers 206 that are geographically dispersed while logically grouped together, or servers 206 that are located proximate to each other while logically grouped together. Geographically dispersed servers 206a-206n within a server farm 206 can, in some embodiments, communicate using a WAN (wide), MAN (metropolitan), or LAN (local), where different geographic regions can be characterized as: different continents; different regions of a continent; different countries; different states; different cities; different campuses; different rooms; or any combination of the preceding geographical locations. In some embodiments the server farm 206 may be administered as a single entity, while in other embodiments the server farm 206 can include multiple server farms.

In some embodiments, a server farm may include servers 206 that execute a substantially similar type of operating system platform (e.g., WINDOWS, UNIX, LINUX, IOS, ANDROID, etc.) In other embodiments, server farm 206 may include a first group of one or more servers that execute a first type of operating system platform, and a second group of one or more servers that execute a second type of operating system platform.

Server 206 may be configured as any type of server, as needed, e.g., a file server, an application server, a web server, a proxy server, an appliance, a network appliance, a gateway, an application gateway, a gateway server, a virtualization server, a deployment server, a Secure Sockets Layer (SSL) VPN server, a firewall, a web server, an application server or as a master application server, a server executing an active directory, or a server executing an application acceleration program that provides firewall functionality, application functionality, or load balancing functionality. Other server types may also be used.

Some embodiments include a first server 206a that receives requests from a client machine 240, forwards the request to a second server 206b (not shown), and responds to the request generated by the client machine 240 with a response from the second server 206b (not shown.) First server 206a may acquire an enumeration of applications available to the client machine 240 as well as address information associated with an application server 206 hosting an application identified within the enumeration of applications. First server 206a can then present a response to the client's request using a web interface, and communicate directly with the client 240 to provide the client 240 with access to an identified application. One or more clients 240 and/or one or more servers 206 may transmit data over network 230, e.g., network 101.

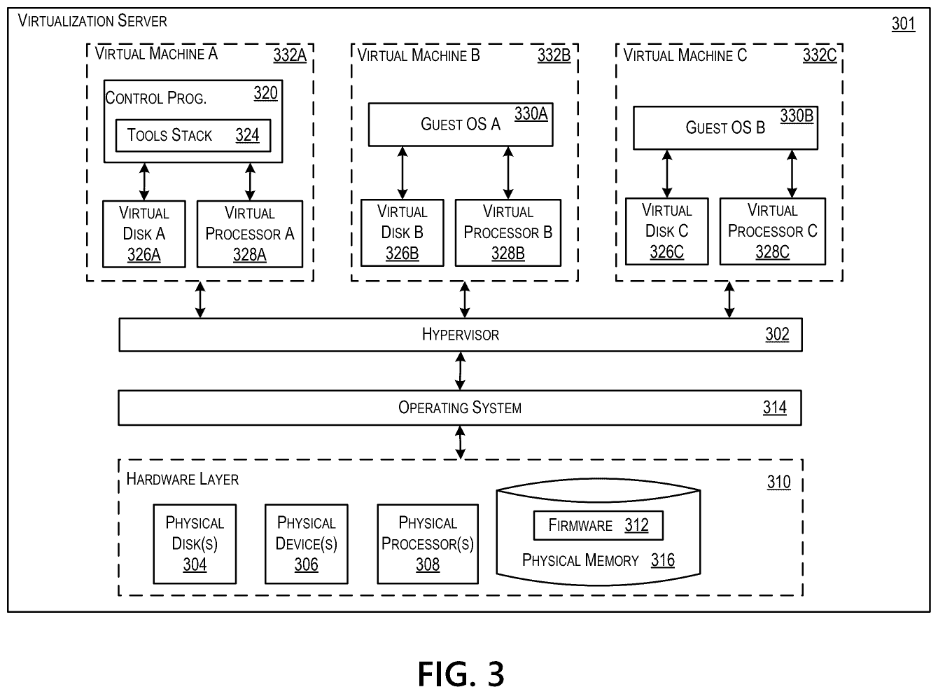

FIG. 3 shows a high-level architecture of an illustrative desktop virtualization system. As shown, the desktop virtualization system may be single-server or multi-server system, or cloud system, including at least one virtualization server 301. As used herein, a desktop refers to a graphical environment or space in which one or more applications may be hosted and/or executed. A desktop may include a graphical shell providing a user interface for an instance of an operating system in which local and/or remote applications can be integrated. Applications may include programs that execute after an instance of an operating system (and, optionally, also the desktop) has been loaded. Each instance of the operating system may be physical (e.g., one operating system per device) or virtual (e.g., many instances of an OS running on a single device). Each application may be executed on a local device, or executed on a remotely located device (e.g., remoted).

A computer device 301 may be configured as a virtualization server in a virtualization environment, for example, a single-server, multi-server, or cloud computing environment. Virtualization server 301 illustrated in FIG. 3 can be deployed as and/or implemented by one or more embodiments of the server 206 illustrated in FIG. 2 or by other known computing devices. Included in virtualization server 301 is a hardware layer that can include one or more physical disks 304, one or more physical devices 306, one or more physical processors 308, and one or more physical memories 316. In some embodiments, firmware 312 can be stored within a memory element in the physical memory 316 and can be executed by one or more of the physical processors 308. Virtualization server 301 may further include an operating system 314 that may be stored in a memory element in the physical memory 316 and executed by one or more of the physical processors 308. Still further, a hypervisor 302 may be stored in a memory element in the physical memory 316 and can be executed by one or more of the physical processors 308.

Executing on one or more of the physical processors 308 may be one or more virtual machines 332A-C(generally 332). Each virtual machine 332 may have a virtual disk 326A-C and a virtual processor 328A-C. In some embodiments, a first virtual machine 332A may execute, using a virtual processor 328A, a control program 320 that includes a tools stack 324. Control program 320 may be referred to as a control virtual machine, Dom0, Domain 0, or other virtual machine used for system administration and/or control. In some embodiments, one or more virtual machines 332B-C can execute, using a virtual processor 328B-C, a guest operating system 330A-B.

Virtualization server 301 may include a hardware layer 310 with one or more pieces of hardware that communicate with the virtualization server 301. In some embodiments, the hardware layer 310 can include one or more physical disks 304, one or more physical devices 306, one or more physical processors 308, and one or more physical memory 316. Physical components 304, 306, 308, and 316 may include, for example, any of the components described above. Physical devices 306 may include, for example, a network interface card, a video card, a keyboard, a mouse, an input device, a monitor, a display device, speakers, an optical drive, a storage device, a universal serial bus connection, a printer, a scanner, a network element (e.g., router, firewall, network address translator, load balancer, virtual private network (VPN) gateway, Dynamic Host Configuration Protocol (DHCP) router, etc.), or any device connected to or communicating with virtualization server 301. Physical memory 316 in the hardware layer 310 may include any type of memory. Physical memory 316 may store data, and in some embodiments may store one or more programs, or set of executable instructions. FIG. 3 illustrates an embodiment where firmware 312 is stored within the physical memory 316 of virtualization server 301. Programs or executable instructions stored in the physical memory 316 can be executed by the one or more processors 308 of virtualization server 301.

Virtualization server 301 may also include a hypervisor 302. In some embodiments, hypervisor 302 may be a program executed by processors 308 on virtualization server 301 to create and manage any number of virtual machines 332. Hypervisor 302 may be referred to as a virtual machine monitor, or platform virtualization software. In some embodiments, hypervisor 302 can be any combination of executable instructions and hardware that monitors virtual machines executing on a computing machine. Hypervisor 302 may be Type 2 hypervisor, where the hypervisor executes within an operating system 314 executing on the virtualization server 301. Virtual machines may then execute at a level above the hypervisor 302. In some embodiments, the Type 2 hypervisor may execute within the context of a user's operating system such that the Type 2 hypervisor interacts with the user's operating system. In other embodiments, one or more virtualization servers 301 in a virtualization environment may instead include a Type 1 hypervisor (not shown). A Type 1 hypervisor may execute on the virtualization server 301 by directly accessing the hardware and resources within the hardware layer 310. That is, while a Type 2 hypervisor 302 accesses system resources through a host operating system 314, as shown, a Type 1 hypervisor may directly access all system resources without the host operating system 314. A Type 1 hypervisor may execute directly on one or more physical processors 308 of virtualization server 301, and may include program data stored in the physical memory 316.

Hypervisor 302, in some embodiments, can provide virtual resources to operating systems 330 or control programs 320 executing on virtual machines 332 in any manner that simulates the operating systems 330 or control programs 320 having direct access to system resources. System resources can include, but are not limited to, physical devices 306, physical disks 304, physical processors 308, physical memory 316, and any other component included in hardware layer 310 of the virtualization server 301. Hypervisor 302 may be used to emulate virtual hardware, partition physical hardware, virtualize physical hardware, and/or execute virtual machines that provide access to computing environments. In still other embodiments, hypervisor 302 may control processor scheduling and memory partitioning for a virtual machine 332 executing on virtualization server 301. Hypervisor 302 may include those manufactured by VMWare, Inc., of Palo Alto, California; HyperV, VirtualServer or virtual PC hypervisors provided by Microsoft, or others. In some embodiments, virtualization server 301 may execute a hypervisor 302 that creates a virtual machine platform on which guest operating systems may execute. In these embodiments, the virtualization server 301 may be referred to as a host server. An example of such a virtualization server is the Citrix Hypervisor provided by Citrix Systems, Inc., of Fort Lauderdale, FL.

Hypervisor 302 may create one or more virtual machines 332B-C(generally 332) in which guest operating systems 330 execute. In some embodiments, hypervisor 302 may load a virtual machine image to create a virtual machine 332. In other embodiments, the hypervisor 302 may execute a guest operating system 330 within virtual machine 332. In still other embodiments, virtual machine 332 may execute guest operating system 330.

In addition to creating virtual machines 332, hypervisor 302 may control the execution of at least one virtual machine 332. In other embodiments, hypervisor 302 may present at least one virtual machine 332 with an abstraction of at least one hardware resource provided by the virtualization server 301 (e.g., any hardware resource available within the hardware layer 310). In other embodiments, hypervisor 302 may control the manner in which virtual machines 332 access physical processors 308 available in virtualization server 301. Controlling access to physical processors 308 may include determining whether a virtual machine 332 should have access to a processor 308, and how physical processor capabilities are presented to the virtual machine 332.

As shown in FIG. 3, virtualization server 301 may host or execute one or more virtual machines 332. A virtual machine 332 is a set of executable instructions that, when executed by a processor 308, may imitate the operation of a physical computer such that the virtual machine 332 can execute programs and processes much like a physical computing device. While FIG. 3 illustrates an embodiment where a virtualization server 301 hosts three virtual machines 332, in other embodiments virtualization server 301 can host any number of virtual machines 332. Hypervisor 302, in some embodiments, may provide each virtual machine 332 with a unique virtual view of the physical hardware, memory, processor, and other system resources available to that virtual machine 332. In some embodiments, the unique virtual view can be based on one or more of virtual machine permissions, application of a policy engine to one or more virtual machine identifiers, a user accessing a virtual machine, the applications executing on a virtual machine, networks accessed by a virtual machine, or any other desired criteria. For instance, hypervisor 302 may create one or more unsecure virtual machines 332 and one or more secure virtual machines 332. Unsecure virtual machines 332 may be prevented from accessing resources, hardware, memory locations, and programs that secure virtual machines 332 may be permitted to access. In other embodiments, hypervisor 302 may provide each virtual machine 332 with a substantially similar virtual view of the physical hardware, memory, processor, and other system resources available to the virtual machines 332.

Each virtual machine 332 may include a virtual disk 326A-C(generally 326) and a virtual processor 328A-C(generally 328.) The virtual disk 326, in some embodiments, is a virtualized view of one or more physical disks 304 of the virtualization server 301, or a portion of one or more physical disks 304 of the virtualization server 301. The virtualized view of the physical disks 304 can be generated, provided, and managed by the hypervisor 302. In some embodiments, hypervisor 302 provides each virtual machine 332 with a unique view of the physical disks 304. Thus, in these embodiments, the particular virtual disk 326 included in each virtual machine 332 can be unique when compared with the other virtual disks 326.

A virtual processor 328 can be a virtualized view of one or more physical processors 308 of the virtualization server 301. In some embodiments, the virtualized view of the physical processors 308 can be generated, provided, and managed by hypervisor 302. In some embodiments, virtual processor 328 has substantially all of the same characteristics of at least one physical processor 308. In other embodiments, virtual processor 308 provides a modified view of physical processors 308 such that at least some of the characteristics of the virtual processor 328 are different than the characteristics of the corresponding physical processor 308.

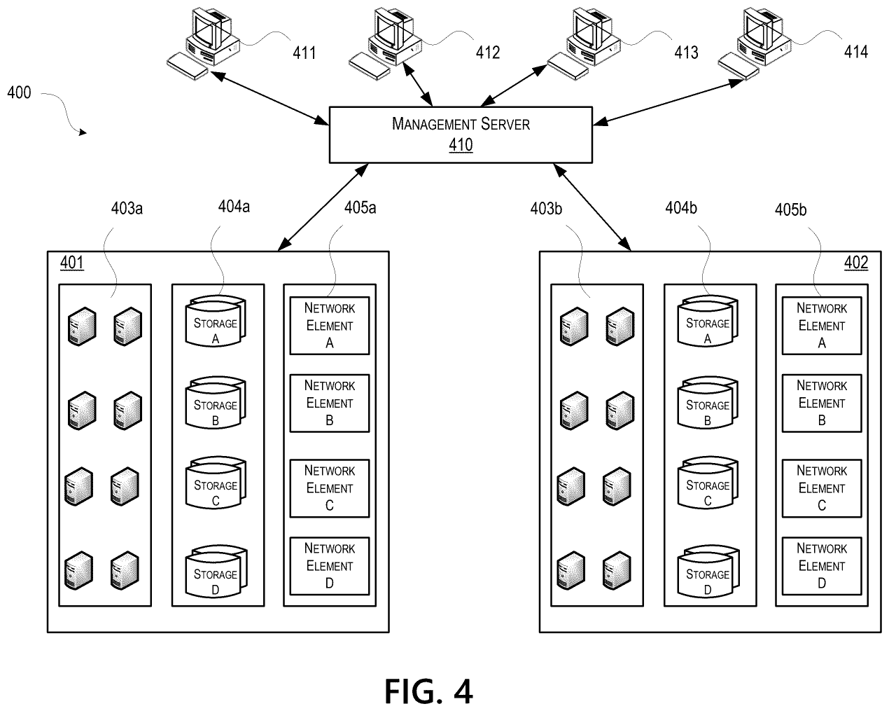

With further reference to FIG. 4, some aspects described herein may be implemented in a cloud-based environment. FIG. 4 illustrates an example of a cloud computing environment (or cloud system) 400. As seen in FIG. 4, client computers 411-414 may communicate with a cloud management server 410 to access the computing resources (e.g., host servers 403a-403b (generally referred herein as “host servers 403”), storage resources 404a-404b (generally referred herein as “storage resources 404”), and network elements 405a-405b (generally referred herein as “network resources 405”)) of the cloud system.

Management server 410 may be implemented on one or more physical servers. The management server 410 may run, for example, Citrix Cloud by Citrix Systems, Inc. of Ft. Lauderdale, FL, or OPENSTACK, among others. Management server 410 may manage various computing resources, including cloud hardware and software resources, for example, host computers 403, data storage devices 404, and networking devices 405. The cloud hardware and software resources may include private and/or public components. For example, a cloud may be configured as a private cloud to be used by one or more particular customers or client computers 411-414 and/or over a private network. In other embodiments, public clouds or hybrid public-private clouds may be used by other customers over an open or hybrid networks.

Management server 410 may be configured to provide user interfaces through which cloud operators and cloud customers may interact with the cloud system 400. For example, the management server 410 may provide a set of application programming interfaces (APIs) and/or one or more cloud operator console applications (e.g., web-based or standalone applications) with user interfaces to allow cloud operators to manage the cloud resources, configure the virtualization layer, manage customer accounts, and perform other cloud administration tasks. The management server 410 also may include a set of APIs and/or one or more customer console applications with user interfaces configured to receive cloud computing requests from end users via client computers 411-414, for example, requests to create, modify, or destroy virtual machines within the cloud. Client computers 411-414 may connect to management server 410 via the Internet or some other communication network, and may request access to one or more of the computing resources managed by management server 410. In response to client requests, the management server 410 may include a resource manager configured to select and provision physical resources in the hardware layer of the cloud system based on the client requests. For example, the management server 410 and additional components of the cloud system may be configured to provision, create, and manage virtual machines and their operating environments (e.g., hypervisors, storage resources, services offered by the network elements, etc.) for customers at client computers 411-414, over a network (e.g., the Internet), providing customers with computational resources, data storage services, networking capabilities, and computer platform and application support. Cloud systems also may be configured to provide various specific services, including security systems, development environments, user interfaces, and the like.

Certain clients 411-414 may be related, for example, to different client computers creating virtual machines on behalf of the same end user, or different users affiliated with the same company or organization. In other examples, certain clients 411-414 may be unrelated, such as users affiliated with different companies or organizations. For unrelated clients, information on the virtual machines or storage of any one user may be hidden from other users.

Referring now to the physical hardware layer of a cloud computing environment, availability zones 401-402 (or zones) may refer to a collocated set of physical computing resources. Zones may be geographically separated from other zones in the overall cloud of computing resources. For example, zone 401 may be a first cloud datacenter located in California, and zone 402 may be a second cloud datacenter located in Florida. Management server 410 may be located at one of the availability zones, or at a separate location. Each zone may include an internal network that interfaces with devices that are outside of the zone, such as the management server 410, through a gateway. End users of the cloud (e.g., clients 411-414) might or might not be aware of the distinctions between zones. For example, an end user may request the creation of a virtual machine having a specified amount of memory, processing power, and network capabilities. The management server 410 may respond to the user's request and may allocate the resources to create the virtual machine without the user knowing whether the virtual machine was created using resources from zone 401 or zone 402. In other examples, the cloud system may allow end users to request that virtual machines (or other cloud resources) are allocated in a specific zone or on specific resources 403-405 within a zone.

In this example, each zone 401-402 may include an arrangement of various physical hardware components (or computing resources) 403-405, for example, physical hosting resources (or processing resources), physical network resources, physical storage resources, switches, and additional hardware resources that may be used to provide cloud computing services to customers. The physical hosting resources in a cloud zone 401-402 may include one or more computer servers 403, such as the virtualization servers 301 described above, which may be configured to create and host virtual machine instances. The physical network resources in a cloud zone 401 or 402 may include one or more network elements 405 (e.g., network service providers) comprising hardware and/or software configured to provide a network service to cloud customers, such as firewalls, network address translators, load balancers, virtual private network (VPN) gateways, Dynamic Host Configuration Protocol (DHCP) routers, and the like. The storage resources in the cloud zone 401-402 may include storage disks (e.g., solid state drives (SSDs), magnetic hard disks, etc.) and other storage devices.

The example cloud computing environment shown in FIG. 4 also may include a virtualization layer (e.g., as shown in FIGS. 1-3) with additional hardware and/or software resources configured to create and manage virtual machines and provide other services to customers using the physical resources in the cloud. The virtualization layer may include hypervisors, as described above in FIG. 3, along with other components to provide network virtualizations, storage virtualizations, etc. The virtualization layer may be as a separate layer from the physical resource layer, or may share some or all of the same hardware and/or software resources with the physical resource layer. For example, the virtualization layer may include a hypervisor installed in each of the virtualization servers 403 with the physical computing resources. Known cloud systems may alternatively be used, e.g., WINDOWS AZURE (Microsoft Corporation of Redmond Washington), AMAZON EC2 (Amazon.com Inc. of Seattle, Washington), IBM BLUE CLOUD (IBM Corporation of Armonk, New York), or others.

### Real-Time History-Based Compression for Unreliable Network Connections

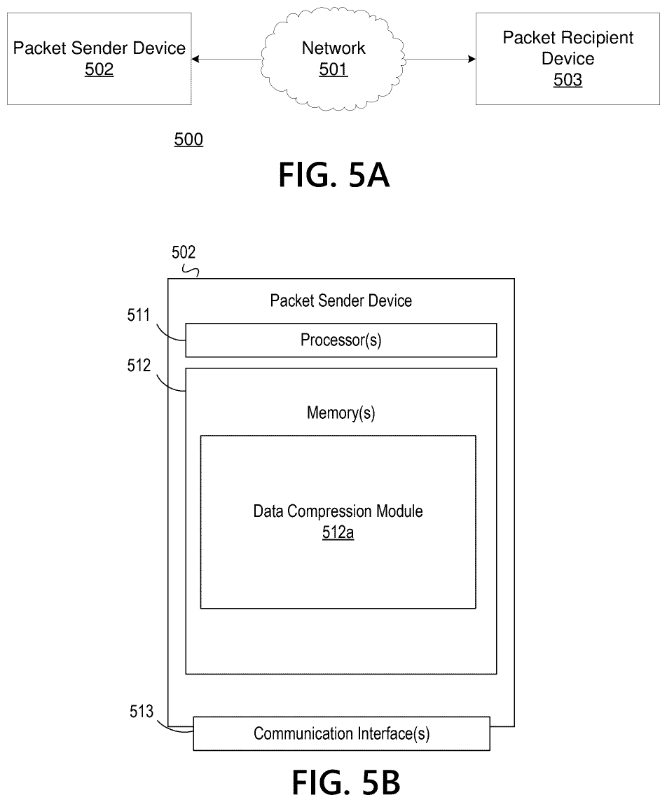

FIGS. 5A-5B depict an illustrative computing environment for performing configuring and implementing real-time history-based compression for unreliable connections in accordance with one or more example embodiments. Referring to FIG. 5A, the computing environment 500 may include one or more computer systems. For example, computing environment 500 may include packet sender device 502 and packet recipient device 503.

As illustrated in greater detail below, packet sender device 502 may be a personal computing device such as a smartphone, tablet, laptop computer, desktop computer, or the like, or may be or include one or more server computers. In some instances, the packet sender device 502 may be configured to send and/or receive data packets. In some instances, the packet sender device 502 may be configured with at least two encoders, configured to compress data packets prior to transmission, and/or at least two expanders, configured to decompress data packets once received. In some instances, each encoder or expander may be part of an encoder/expander pair corresponding to a reducer compression scheme. Although a single packet sender device 502 is depicted, any number of such devices may be implemented in the methods described herein without departing from the scope of the disclosure.

Packet recipient device 503 may be a personal computing device such as a smartphone, tablet, laptop computer, desktop computer, or the like, or may be or include one or more server computers. In some instances, the packet recipient device 503 may be configured to send and/or receive data packets. In some instances, the packet recipient device 503 may be configured with at least two encoders, configured to compress data packets prior to transmission, and/or at least two expanders, configured to decompress data packets once received. In some instances, each encoder or expander may be part of an encoder/expander pair corresponding to a reducer compression scheme. Although a single packet recipient device 503 is depicted, any number of such devices may be implemented in the methods described herein without departing from the scope of the disclosure.

Computing environment 500 may also include one or more networks, which may interconnect packet sender device 502 and packet recipient device 503. For example, computing environment 400 may include a wired or wireless network 501 (which may e.g., connect packet sender device 502 and packet recipient device 503).

In one or more arrangements, packet sender device 502, packet recipient device 503, and/or the other systems included in the computing environment may be any type of computing device capable of receiving data packets and/or communicating the data packets to one or more other computing devices. For example, packet sender device 502, packet recipient device 503, and/or the other systems included in the computing environment may in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of packet sender device 502 and packet recipient device 503 may, in some instances, be special purpose computing devices configured to perform specific functions.

Referring to FIG. 5B, packet sender device 502 may include one or more processors 511, memory 512, and communication interface 513. A data bus may interconnect processor 511, memory 512, and communication interface513. Communication interface 513 may be a network interface configured to support communication between the packet sender device 502 and one or more networks (e.g., network 501, or the like). Memory 512 may include one or more program modules having instructions that when executed by processor 511 cause packet sender device 502 to perform one or more functions described herein and/or access one or more databases that may store and/or otherwise maintain information which may be used by such program modules and/or processor 511. In some instances, the one or more program modules and/or databases may be stored by and/or maintained in different memory units of packet sender device 502 and/or by different computing devices that may form and/or otherwise make up packet sender device 502. For example, memory 512 may have, host, store, and/or include a data compression module 512a that may direct and/or otherwise cause packet sender device 502 to maintain at least two instances of a packet encoder and/or expander configured to compress and/or decompress packets accordingly.

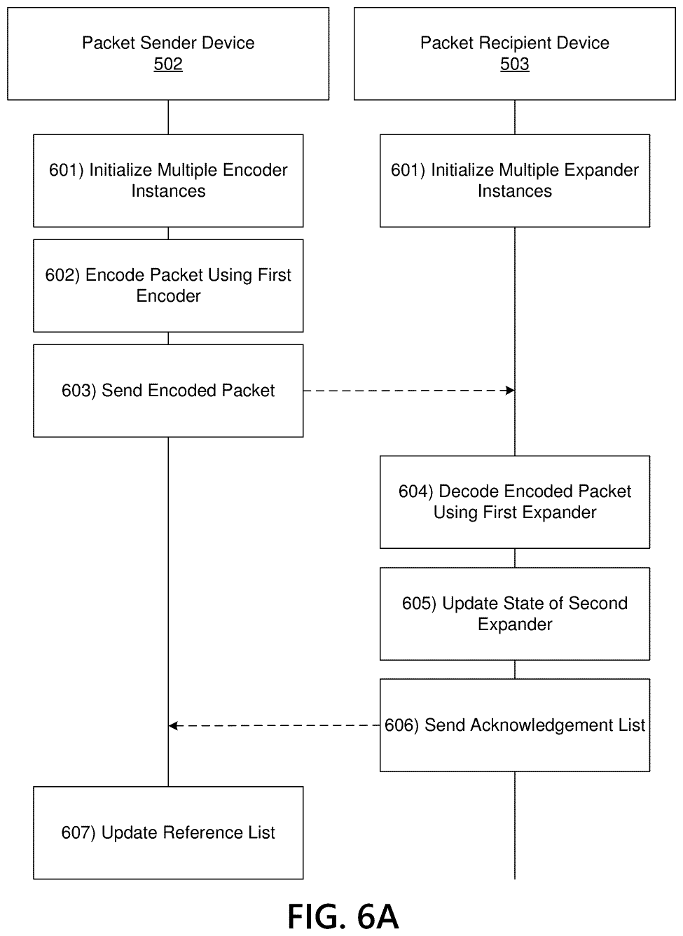

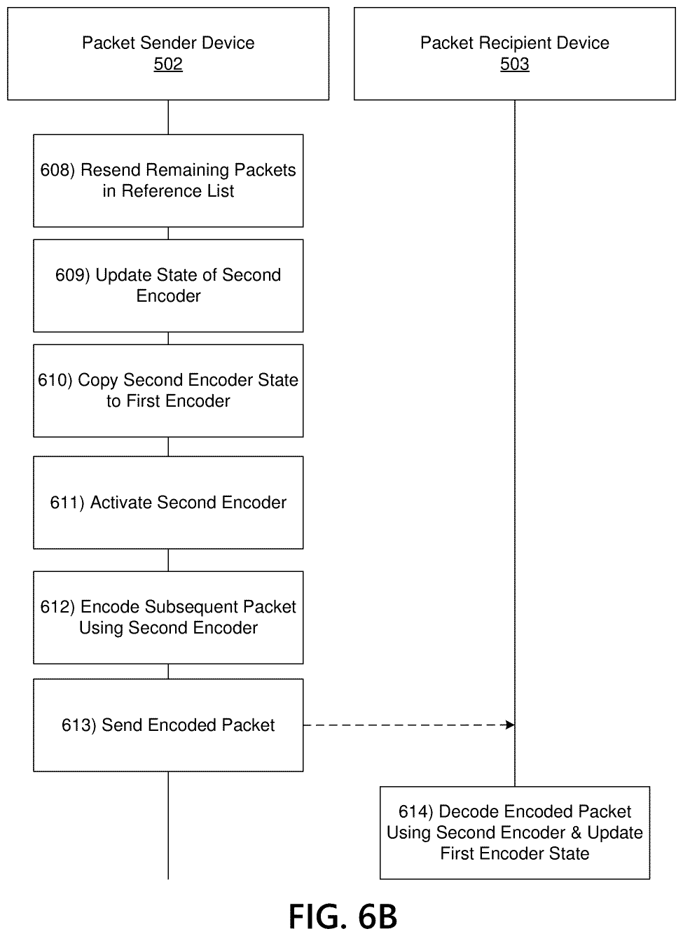

FIGS. 6A-6B depict an illustrative event sequence for real-time history-based compression for unreliable network connections in accordance with one or more example embodiments. It should be understood that steps 601-614 may, in some instances, occur in the order as shown with regard to FIGS. 6A-6B. For example, after completing step 607 of FIG. 6A, the event sequence may proceed to step 608 of FIG. 6B.

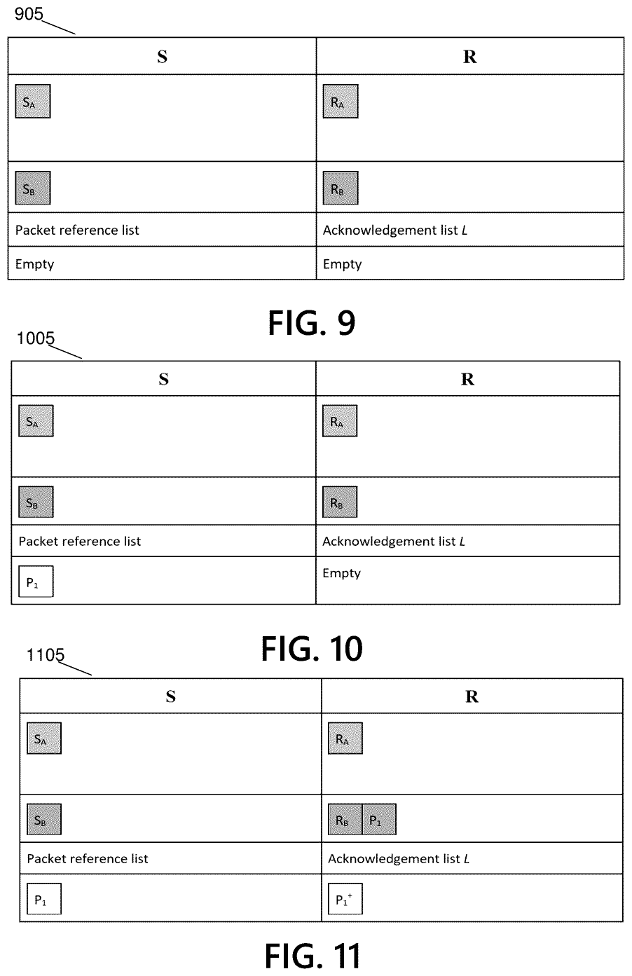

Referring to FIG. 6A, at step 601, the packet sender device 502 and/or the packet recipient device 503 may instantiate at least two instances of a reducer compression scheme. For example, the packet sender device 502 may instantiate at least two instances of an encoder and the packet recipient device 503 may instantiate at least two instances of an expander. For example, each instance of the compression scheme may have an instance of the encoder at the packet sender device 502 and an instance of the expander at the packet recipient device 503. In these instances, the encoder instances may be configured to encode/compress packets for transmission, and the expander instances may be configured to decode/expand received packets. As a particular example, the packet sender device 502 (represented by column “S”) may have two instances of the compression scheme (S_{A} and S_{B}) and the packet recipient device 503 (represented by column “R”) may have two instances of the compression scheme (RA and RB), as shown in chart 905 of FIG. 9. As shown in FIG. 9, the packet sender device 502 may maintain a packet reference list (which may, e.g., be empty upon initialization) and the packet recipient device 503 may maintain an acknowledgement list (which may, e.g., be empty upon initialization).

At step 602, the packet sender device 502 may encode a packet using the first instance of the encoder to produce an encoded packet. For example, the packet sender device 502 may encode the packet P₁ to produce encoded packet EP₁ as shown in chart 1005 of FIG. 10.

At step 603, the packet sender device 502 may send the encoded packet to the packet recipient device 503. In some instances, the packet sender device 502 may also maintain a reference to P₁ in the packet reference list as shown in FIG. 10. In some instances, the packet sender device 502 may also transmit a single bit indicating which compression scheme (i.e., the first scheme S_{A}, the second scheme S_{B}, or another scheme) is implemented. For example, the packet sender device 502 may set the bit to 0 to indicate that the first scheme is in use, or may set the bit to 1 to indicate that the second scheme is in use. For illustrative purposes, it may be assumed that the packet sender device 502 may set the bit to 0 in this case to indicate that the first scheme is in use. In these instances, the packet sender device 502 might not update the state of either the first encoder instance or the second encoder instance to reflect the transmission of the first packet P₁. In some instances, to improve a likelihood of the packets being received, the packet sender device 502 may transmit one or more copies of the same packet.

At step 604, assuming that the packet was not lost in transmission, the packet recipient device 503 may receive the packet sent at step 603. For example, as illustrated in chart 1105 of FIG. 11, the packet recipient device 503 may receive encoded packet EP₁. The packet recipient device 503 may decode the encoded packet. For example, the packet recipient device 503 may decode the encoded packet using the first instance of the expander. For example, as shown in FIG. 11, the packet recipient device 503 may decode the encoded packet received at step 604 using RA to reproduce P₁.

At step 605, the packet recipient device 503 may update the state of the second instance of the expander based on the packet decoded at step 605. For example, as shown in FIG. 11, the packet recipient device 503 may use a plus sign (i.e., P₁⁺) to indicate that the packet recipient device 503 used the decoded packet P₁ to update its second instance of the expander. As a result, when the acknowledgement list is sent to the packet sender device 502, the packet sender device 502 knows to update its second instance of the encoder with P₁ as well. Alternatively, the packet recipient device 503 might not use the plus sign (i.e., P₁). In these instances, the packet sender device 502 knows that the packet recipient device 503 received P₁ but did not use it to update the state of the second instance of the expander (and thus the packet sender device 502 similarly should not update the second instance of the packet encoder).

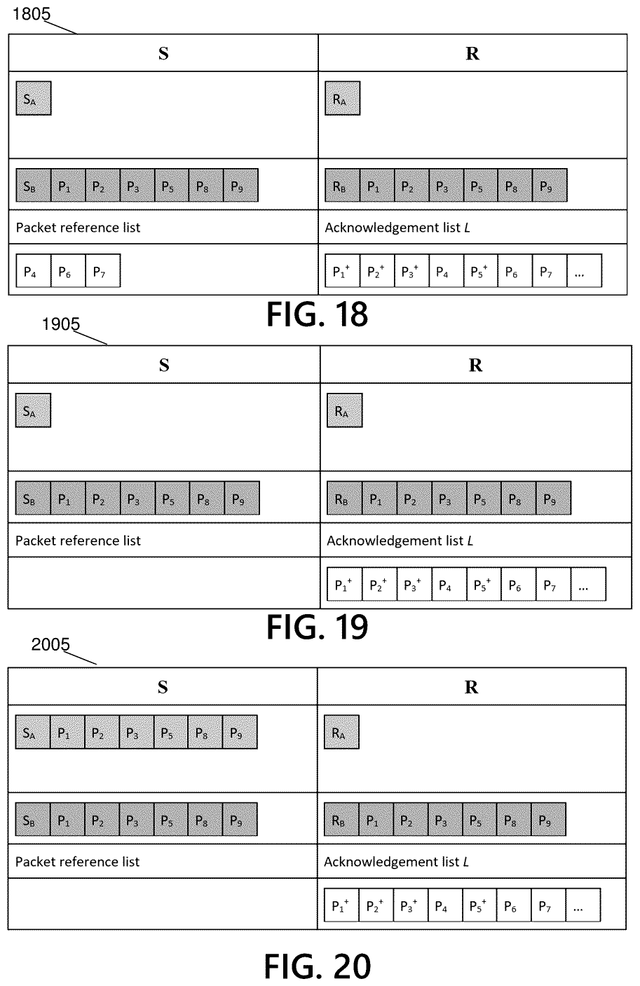

In some instances, the packet recipient device 503 might decide not to use certain packets. Nevertheless, an indication of these packets may still be added to the acknowledgement list. In these instances, however, the bit indicating whether or not they were used to update the state of an expander instance might not be set. This is illustrated, for example, in chart 1805 of FIG. 18. For example, if packets P₄, P₆, and P₇ are not used by the packet recipient device 503, they may be added to the acknowledgement list, but neither a plus nor minus sign may be associated with the packet reference (i.e., because the corresponding bit might not be sent).

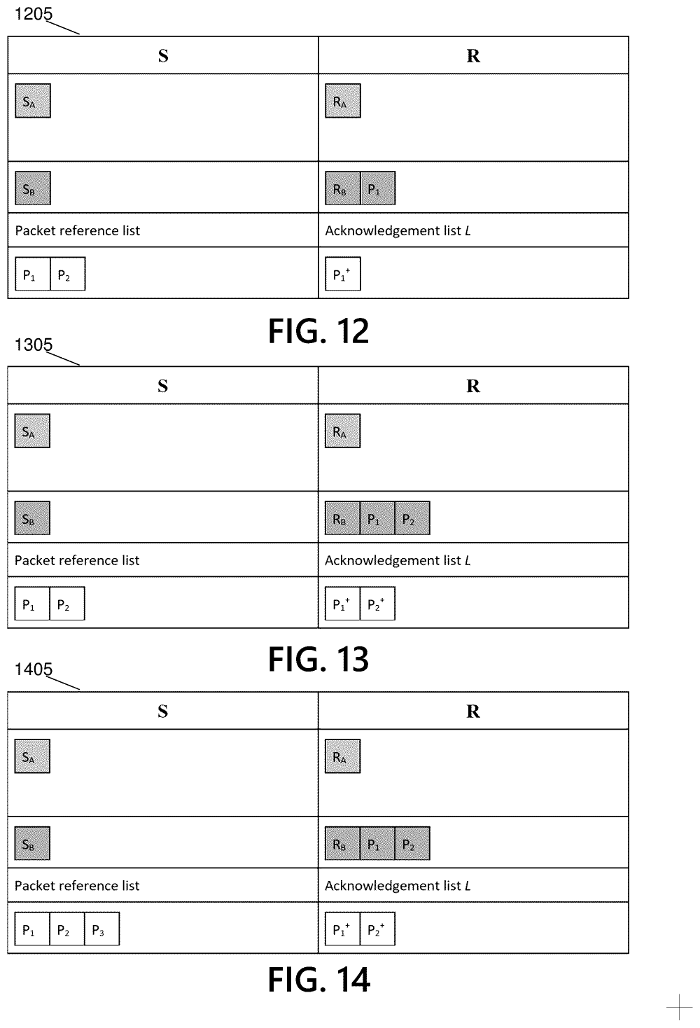

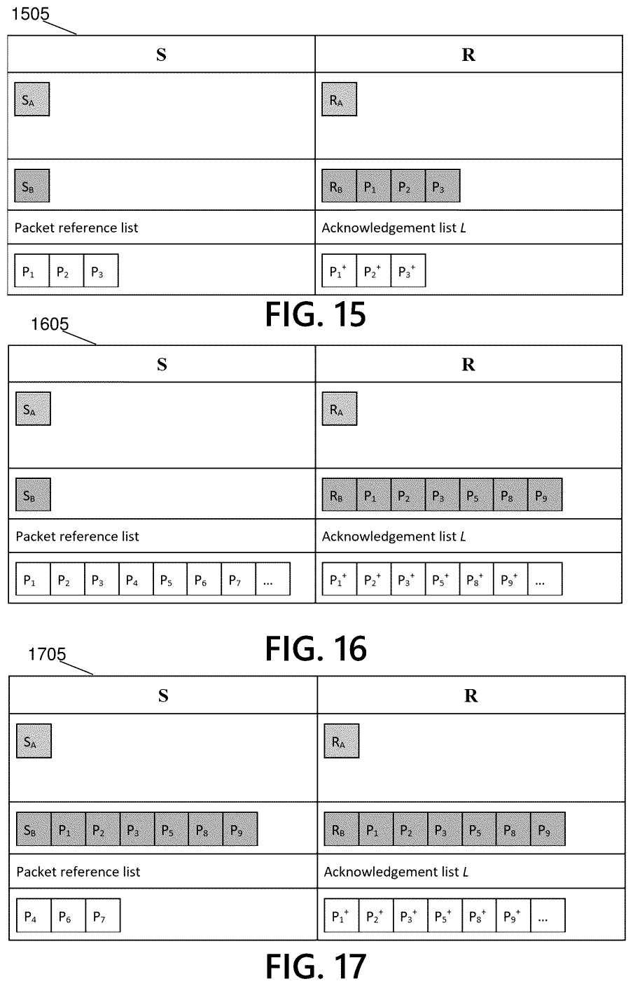

In some instances, the packet sender device 502 may continue to encode packets using the first instance of the encoder, update the packet reference list, and send the encoded packets to the to the packet recipient device 503. Similarly, the packet recipient device 503 may continue to decode the encoded packets using the second instance of the expander, update the state of the second instance of the encoder, and record this action in the acknowledgement list. For example, this is illustrated with regard to charts 1205-1505, which are shown in FIGS. 12-15, and which reflect the transmission of a second and third packet. Although a second and third packet are illustrated in these figures, any number of packets may be sent, processed, and/or otherwise received without departing from the scope of the disclosure. For example, as is illustrated in chart 1605 of FIG. 16, up to packet P₉ may be sent/received.

At step 606, the packet recipient device 503 may transmit the acknowledgement list to the packet sender device 502. For example, the packet recipient device 503 may send the acknowledgement list at a predetermined interval, based on detecting that a predetermined number of packets are included in the acknowledgement list, after expiration of a predetermined period of time of inactivity, and/or otherwise. This is illustrated, for example, in chart 1605, which is shown in FIG. 16. In some instances, however, the encodings for all transmitted packets might not be received by the packet recipient device 503 (i.e., due to the unreliable network connection). For example, as shown in FIG. 16, although packets P₄, P₆, and P₇ are included in the packet list at the packet sender device 502 (thus indicating that these packets have been sent), the acknowledgement list at the packet recipient device 503 might not include these packets (thus indicating that the packets were lost in transmission).

In some instances, despite the transmission of the acknowledgement list, the packet sender device 502 may continue to transmit packets to the packet recipient device 503 (though, as described above, the packet recipient device 503 might not necessarily receive all transmitted packets due to the unreliable network connection.

At step 607, the packet sender device 502 may receive the acknowledgement list sent at step 606, and may iterate through the list. For example, for every packet Pᵢ included in the acknowledgement list, the packet sender device 502 may update the state of the second instance of the encoder as shown in chart 1705, which is illustrated in FIG. 17.

In some instances, the packet recipient device 503 may decide in what order and what packets may be used to update the state of the second instance of the expander, and may communicate this to the packet sender device 502 so that it may do the same. As such, if packet Pᵢ is not decoded by the packet recipient device (i.e., because it is lost, or the like), the packet recipient device might not have used it to update the state of the second instance of the expander, and would therefore not have been added to the acknowledgement list. Thus, because Pᵢ might not be in the acknowledgement list in these instances, the packet sender device 502 might not update the state of its second instance of the encoder with the reference it held to Pᵢ.

The point at which the packet sender device 502 switches between states of the encoder may be critical. For example, an explicit sender-receiver compression scheme synchronization step might not be introduced, as it may impact application interactivity. Instead, the packet sender device 502 may infer from the references it is holding on to whether the packet recipient device 503 has received and processed all of the packets that the packet sender device 502 has sent. An empty list may indicate that all packets have been processed and it is a safe point to switch compression states before emitting the next packet and toggling the identifier bit.

After updating the state of the second instance of the encoder for a particular packet, the packet sender device 502 may release the reference to the corresponding packet from the packet reference list. For example, as shown in FIG. 17, because the state of the second instance of the encoder has been updated to include P₁, P₂, P₃, P₅, P₈, and P₉, these references may be removed from the packet reference list. However, because the acknowledgement list did not include P₄, P₆, and P₇, the state of the second instance of the encoder might not be updated to include these packets. Accordingly, the references to these packets may remain in the packet reference list.

If any packet references remain in the reference list, the packet sender device 502 may proceed to step 608. Otherwise, if no packet references remain, the packet sender device 502 may proceed to step 609.

Referring to FIG. 6B, at step 608, the packet sender device 502 may retransmit any packets remaining in the reference list. For example, the packet sender device 502/packet recipient device 503 may repeat the encoding/transmission/decoding/acknowledgement steps described above with regard to steps 602-607 for any remaining packets. In some instances, the packet sender device 502 may identify whether or not to perform this retransmission based on a content of the data packets. For example, in some instances, the packet sender device 502 may identify that a glitch or error caused by the unreceived packets may be negligible, within a window of tolerance, or the like, and thus might not resend the packets. In some instances, to improve a likelihood of the packets being received, the packet sender device 502 may transmit one or more copies of the same packet. In some instances, the packet sender device 502 and packet recipient device 503 may continue to repeat these steps 602-608 until all transmitted packets may eventually be acknowledged.

At step 609, the packet sender device 502 may continue to update a state of the second instance of the encoder based on any further packet acknowledgements (similar to the updates described above at step 607). In some instances, where any of these previously missing entries do not include an update bit (i.e., indicated by the plus or minus notation described above), the packet sender device 502 might not update the state of the second instance of the packet encoder to reflect these packets. For example, as shown in FIG. 18, S_{B} and RB might not be updated to reflect P₄, P₆, and P₇ (despite these packets being retransmitted and received). Once the states of these second instances have been updated, the packet sender device 502 may clear the packet reference list, and may, in some instances, refrain from sending additional interim packets.

At step 610, the packet sender device 502 may switch compression schemes (e.g., from the second instances of the encoder/expander to the first instances of the encoder expander, such as from S_{A} to S_{B}). For example, at this point, as illustrated in chart 1905 of FIG. 19, the packet reference list may now be empty, and the second instances of the encoder/expander may have identical compression states and history buffers. Accordingly, at this point, it may be safe to switch from a second compression scheme to a first compression scheme. As a result, the packet sender device 502 may copy the state of the second instances of the encoder over to update the state of the first instance of the encoder (e.g., as illustrated in chart 2005 of FIG. 20).

At step 611, once the state of the first instance of the encoder has been updated, the packet sender device 502 may switch over to using the second instance of the encoder (e.g., S_{B}) for the transmission of subsequent packets. As a result, the packet sender device 502 may benefit from the history that has been built up in the corresponding state.

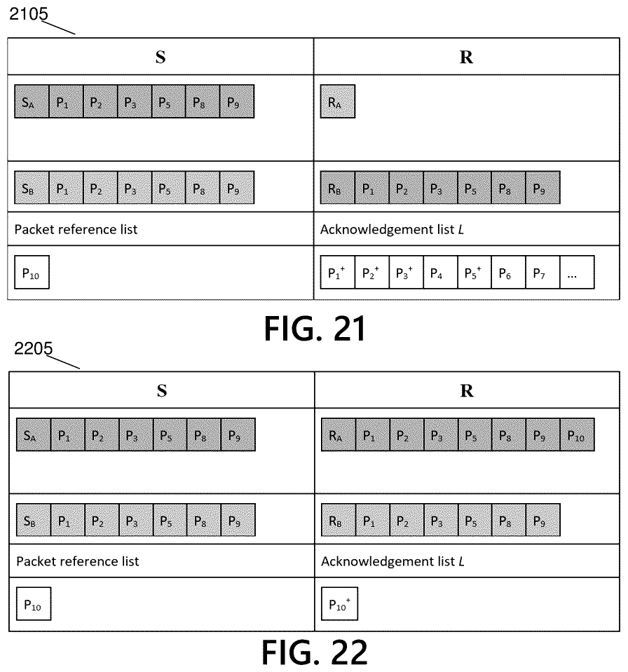

At step 613, the packet sender device 502 may encode, using the second instance of the encoder, a subsequent packet (such as P₁₀ as depicted in chart 2105 of FIG. 21) to produce an encoded packet, such as EP₁₀. In these instances, the packet sender device 502 may keep a reference to the subsequent packet in the packet reference list (e.g., P₁₀ is added to the reference list in FIG. 21). In light of the update to encoder instance, the packet sender device 502 may update the identifier bit (e.g., from zero to one), thus indicating that the second instance of the expander should be used for decoding by the packet recipient device 502. As described above with regard to the initial packets, the packet sender device 502 might not update the state of either the first or second instance of the encoder at this time based on the current packet. At step 612, the packet sender device 502 may send the packet, encoded at step 614, to the packet recipient device 503.

At step 614, assuming that the packet, sent at step 613 is not lost, the packet recipient device 503 may note that the identifier has been updated to one (and thus is different than the last identifier). Based on this identifier, the packet recipient device 503 may switch to using the second instance of the expander (e.g., RB). For example, as illustrated in chart 2205 of FIG. 22, the packet recipient device 503 may clear the existing acknowledgement list and decode the packet using the second instance of the expander (e.g., decode EP₁₀ using RB to reproduce P₁₀). The packet recipient device 503 may then use P₁₀ to update the state of the first instance of the expander, and record this action in a new acknowledgement list. For example, the packet recipient device 503 may have cleared any information previously included in the acknowledgement list.

It may be important to note that the packet recipient device 503 may only clear the acknowledgement list if it receives a different identifier bit from the packet sender device 502, indicating that the packet sender device 502 has received the acknowledgement list. The packet recipient device 503 may choose to transmit the acknowledgement list at any point, and may continue to retransmit the acknowledgement list until it has received a different identifier bit. It might not matter if the packet sender device receives multiple copies of the acknowledgement list, as every packet may have a sequence number by which the packet sender device 502 may know if the acknowledgement list has already been processed. Similarly, it might not matter if the packet recipient device 503 may receive a duplicate encoded packet EPᵢ, since it too may have a sequence number by which the packet recipient device 503 may determine if it has already been processed.

This process may continue, with the packet sender device 502 and the packet recipient device 503 switching between their respective compression states, building up valuable compression state and history buffer contents as more packets are compressed.

Although a particular number of packets are illustrated in the figures and above described event sequence, any number of packets may be encoded, transmitted, and decoded (as described above) without departing from the scope of the disclosure.

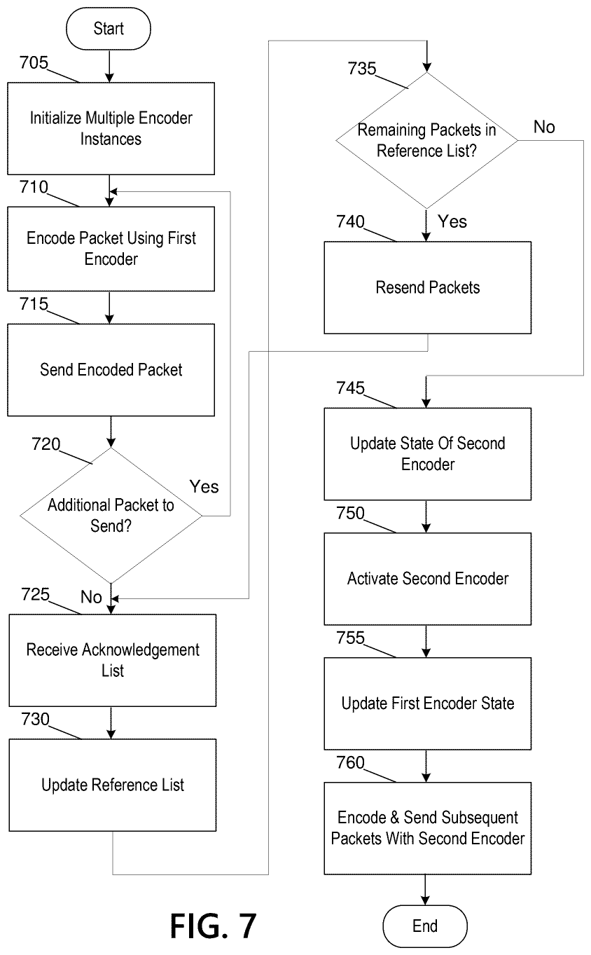

FIG. 7 depicts an illustrative method for performing real-time history based compression for unreliable networks in accordance with one or more example embodiments. Referring to FIG. 7, at step 705, a computing system comprising a memory and one or more processors may initialize multiple instances of a compression scheme (i.e., multiple instances of a packet encoder). At step 710, the computing system may encode a packet using the first instance of the encoder and update a reference list based on the packet. At step 715, the computing system may send the encoded packet to a recipient. At step 720, the computing system may identify whether another packet is queued for encoding. If so, the computing system may return to step 710. Otherwise, the computing system may proceed to step 725.

At step 725, the computing system may receive an acknowledgement list from the recipient. At step 730, the computing system may update the reference list based on the acknowledgement list. At step 735, the computing system may identify whether any packets are remaining in the reference list. If so, the computing system may proceed to step 740. For example, at step 740, the computing system may resend any remaining packets, and return to step 725.

Otherwise, if there are no packets remaining in the reference list, the computing system may proceed to step 745. At step 745, the computing system may update a state of a second instance of the encoder. At step 750, the computing system may activate the second instance of the encoder. At step 755, the computing system may update the state of the first instance of the encoder. At step 760, the computing system may encode and send subsequent packets using the second instance of the encoder.

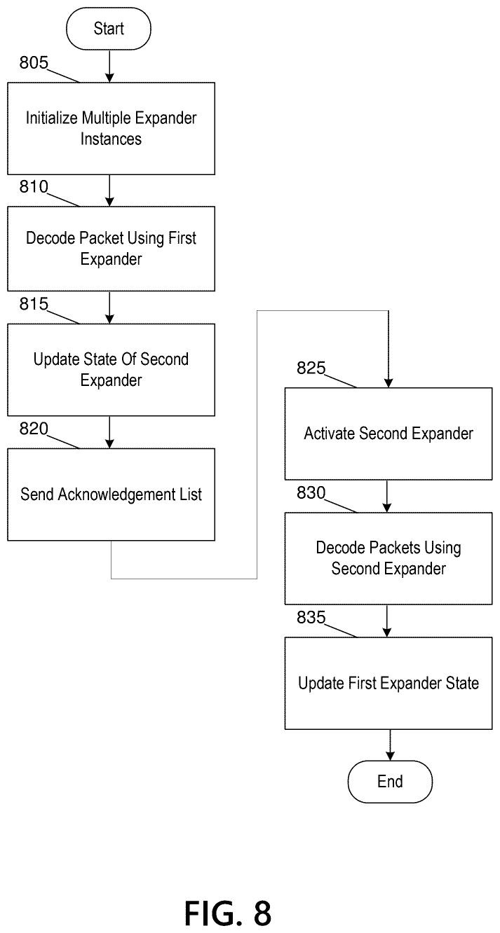

FIG. 8 depicts an illustrative method for performing real-time history based compression for unreliable networks in accordance with one or more example embodiments. Referring to FIG. 8, at step 805, a computing system comprising a memory and one or more processors may initialize multiple instances of a compression scheme (e.g., packet expander). At step 810, the computing system may receive a packet and decode it using a first instance of the expander. At step 815, the computing system may update a state of a second instance of the expander. At step 820, the computing system may send an acknowledgement list to a packet sender, indicating received packets. At step 825, the computing system may activate the second instance of the expander. At step 830, the computing system may decode subsequent packets using the second instance of the expander. At step 835, the computing system may update the state of the first instance of the expander.

The following paragraphs (M1) through (M13) describe examples of methods that may be implemented in accordance with the present disclosure.

(M1) A method comprising: initializing, at a packet sender device, a first instance of an encoder and a second instance of the encoder, wherein the first instance of the encoder and the second instance of the encoder are configured to encode packets for transmission to packet recipient devices; encoding, at the packet sender device and using the first instance of the encoder, a first packet; storing, at the packet sender device and using a packet reference list, a reference to the first packet; transmitting, to a first packet recipient device, the first encoded packet; receiving, from the first packet recipient device, an acknowledgement list indicating the first packet; and based on identifying that the acknowledgement list matches the packet reference list: updating a state of the second instance of the encoder based on the packet reference list, clearing the packet reference list, updating a state of the first instance of the encoder to match a state of the second instance of the encoder, and switching from use of the first instance of the encoder to the second instance of the encoder.

(M2) The method as described in paragraph (M1), wherein the first instance of the encoder corresponds to a first compression scheme and the second instance of the encoder corresponds to a second compression scheme, the first packet recipient device is configured with a first instance of an expander and a second instance of the expander, and the first instance of the expander corresponds to the first compression scheme and the second instance of the expander corresponds to the second compression scheme.

(M3) The method as described in paragraph (M2), wherein transmitting the first encoded packet further includes transmitting a single bit indicating that the first compression scheme is in use.

(M4) The method as described in paragraph (M3), wherein the first packet recipient device decodes, based on the single bit indicating that the first compression scheme is in use, the first encoded packet using the first instance of the expander.

(M5) The method as described in paragraph (M4), wherein the first packet recipient device: updates a state of the second instance of the expander; and records the update to the state of the second instance of the expander in the acknowledgement list with a positive indicator bit indicating that the first encoded packet was used to update the state of the second instance of the expander at the first packet recipient device.

(M6) The method as described in any of paragraphs (M1) through (M5), wherein transmitting the first encoded packet comprises transmitting, without updating the state of the first instance of the encoder.

(M7) The method as described in any of paragraphs (M1) through (M6), wherein a connection between the packet sender device and the first packet recipient device comprises an unreliable network connection.

(M8) The method as described in paragraph (M7), wherein the transmission of the first encoded packet to the first packet recipient device fails due to the unreliable network connection.

(M9) The method as described in paragraph (M8), further comprising: identifying, based on the acknowledgement list, any encoded packets for which transmission failed.

(M10) The method as described in any of paragraphs (M2) through (M9), wherein subsequent packets are encoded using the second instance of the encoder rather than the first instance of the encoder.

(M11) The method as described in paragraph (M10), wherein a first subsequent packet is sent to the first packet recipient device along with an identifier bit that causes the second instance of the expander to activate, rather than the first instance of the expander.

(M12) The method as described in paragraph (M11), wherein, based on activation of the second instance of the expander, the first packet recipient device updates a state of the second instance of the expander based on a state of the first instance of the expander.

(M13) The method as described in any of paragraphs (M1) through (M12), wherein updating the state of the second instance of the encoder based on the packet reference list is based on detection of an indicator bit, included in the packet reference list, indicating an instruction from the first packet recipient device to update the state of the second instance of the encoder.

The following paragraphs (A1) through (A6) describe examples of apparatuses that may be implemented in accordance with the present disclosure.

(A1) A computing system comprising: one or more processors; memory storing computer executable instructions that, when executed by the processor, cause the computing system to: initialize a first instance of an encoder and a second instance of the encoder, wherein the first instance of the encoder and the second instance of the encoder are configured to encode packets for transmission to packet recipient devices; encode, using the first instance of the encoder, a first packet; store, using a packet reference list, a reference to the first packet; transmit, to a first packet recipient device, the first encoded packet; receive, from the first packet recipient device, an acknowledgement list indicating the first packet; and based on identifying that the acknowledgement list matches the packet reference list: update a state of the second instance of the encoder based on the packet reference list, clear the packet reference list, update a state of the first instance of the encoder to match a state of the second instance of the encoder, and switch from use of the first instance of the encoder to the second instance of the encoder.

(A2) The computing system described in paragraph (A1) wherein: the first instance of the encoder corresponds to a first compression scheme and the second instance of the encoder corresponds to a second compression scheme, the first packet recipient device is configured with a first instance of an expander and a second instance of the expander, and the first instance of the expander corresponds to the first compression scheme and the second instance of the expander corresponds to the second compression scheme.

(A3) The computing system described in paragraph (A2), wherein transmitting the first encoded packet further includes transmitting a single bit indicating that the first compression scheme is in use.

(A4) The computing system described in paragraph (A3), wherein the first packet recipient device decodes, based on the single bit indicating that the first compression scheme is in use, the first encoded packet using the first instance of the expander.

(A5) The computing system described in paragraph (A4), wherein the first packet recipient device: updates the state of the second instance of the expander; and records the update to the state of the second instance of the expander in the acknowledgement list with a positive indicator bit indicating that the first encoded packet was used to update the state of the second instance of the expander at the first packet recipient device.

(A6) The computing system described in paragraph (A5), wherein transmitting the first encoded packet comprises transmitting, without updating the state of the first instance of the encoder.

The following paragraph (CRM1) describes examples of computer-readable media that may be implemented in accordance with the present disclosure.

(CRM1) One or more non-transitory computer-readable media storing instructions that, when executed by a computing system comprising at least one processor, a communication interface, and memory, cause the computing system to: initialize, at a packet sender device, a first instance of an encoder and a second instance of the encoder, wherein the first instance of the encoder and the second instance of the encoder are configured to encode packets for transmission to packet recipient devices; encode, at the packet sender device and using the first instance of the encoder, a first packet; store, at the packet sender device and using a packet reference list, a reference to the first packet; transmit, to a first packet recipient device, the first encoded packet; receive, from the first packet recipient device, an acknowledgement list indicating the first packet; and based on identifying that the acknowledgement list matches the packet reference list: update a state of the second instance of the encoder based on the packet reference list, clear the packet reference list, update a state of the first instance of the encoder to match a state of the second instance of the encoder, and switch from use of the first instance of the encoder to the second instance of the encoder.

Although the subject matter has been described in language specific to structural features and/or methodological acts, it is to be understood that the subject matter defined in the appended claims is not necessarily limited to the specific features or acts described above. Rather, the specific features and acts described above are described as example implementations of the following claims.

What is claimed is:

1. A method comprising:
initializing, at a packet sender device, a first instance of an encoder and a second instance of the encoder, wherein the first instance of the encoder and the second instance of the encoder are configured to encode packets for transmission to packet recipient devices;
encoding, at the packet sender device and using the first instance of the encoder, a first packet;
storing, at the packet sender device and using a packet reference list, a reference to the first packet;
transmitting, to a first packet recipient device, the first encoded packet;
receiving, from the first packet recipient device, an acknowledgement list indicating the first packet; and
based on identifying that the acknowledgement list matches the packet reference list:
updating a state of the second instance of the encoder based on the packet reference list,
clearing the packet reference list,
updating a state of the first instance of the encoder to match a state of the second instance of the encoder, and
switching from use of the first instance of the encoder to the second instance of the encoder.

2. The method of claim 1, wherein:
the first instance of the encoder corresponds to a first compression scheme and the second instance of the encoder corresponds to a second compression scheme,
the first packet recipient device is configured with a first instance of an expander and a second instance of the expander, and
the first instance of the expander corresponds to the first compression scheme and the second instance of the expander corresponds to the second compression scheme.

3. The method of claim 2, wherein transmitting the first encoded packet further includes transmitting a single bit indicating that the first compression scheme is in use.

4. The method of claim 3, wherein the first packet recipient device decodes, based on the single bit indicating that the first compression scheme is in use, the first encoded packet using the first instance of the expander.

5. The method of claim 4, wherein the first packet recipient device:
updates a state of the second instance of the expander; and
records the update to the state of the second instance of the expander in the acknowledgement list with a positive indicator bit indicating that the first encoded packet was used to update the state of the second instance of the expander at the first packet recipient device.

6. The method of claim 1, wherein transmitting the first encoded packet comprises transmitting, without updating the state of the first instance of the encoder.

7. The method of claim 1, wherein a connection between the packet sender device and the first packet recipient device comprises an unreliable network connection.

8. The method of claim 7, wherein the transmission of the first encoded packet to the first packet recipient device fails due to the unreliable network connection.

9. The method of claim 8, further comprising:
identifying, based on the acknowledgement list, any encoded packets for which transmission failed.

10. The method of claim 2, wherein subsequent packets are encoded using the second instance of the encoder rather than the first instance of the encoder.

11. The method of claim 10, wherein a first subsequent packet is sent to the first packet recipient device along with an identifier bit that causes the second instance of the expander to activate, rather than the first instance of the expander.

12. The method of claim 11, wherein, based on activation of the second instance of the expander, the first packet recipient device updates a state of the second instance of the expander based on a state of the first instance of the expander.

13. The method of claim 1, wherein updating the state of the second instance of the encoder based on the packet reference list is based on detection of an indicator bit, included in the packet reference list, indicating an instruction from the first packet recipient device to update the state of the second instance of the encoder.

14. A computing system comprising:
one or more processors;
memory storing computer executable instructions that, when executed by the processor, cause the computing system to:
initialize a first instance of an encoder and a second instance of the encoder, wherein the first instance of the encoder and the second instance of the encoder are configured to encode packets for transmission to packet recipient devices;
encode, using the first instance of the encoder, a first packet;
store, using a packet reference list, a reference to the first packet;
transmit, to a first packet recipient device, the first encoded packet;
receive, from the first packet recipient device, an acknowledgement list indicating the first packet; and
based on identifying that the acknowledgement list matches the packet reference list:
update a state of the second instance of the encoder based on the packet reference list,
clear the packet reference list,
update a state of the first instance of the encoder to match a state of the second instance of the encoder, and
switch from use of the first instance of the encoder to the second instance of the encoder.

15. The computing system of claim 14, wherein:
the first instance of the encoder corresponds to a first compression scheme and the second instance of the encoder corresponds to a second compression scheme,
the first packet recipient device is configured with a first instance of an expander and a second instance of the expander, and
the first instance of the expander corresponds to the first compression scheme and the second instance of the expander corresponds to the second compression scheme.

16. The computing system of claim 15, wherein transmitting the first encoded packet further includes transmitting a single bit indicating that the first compression scheme is in use.

17. The computing system of claim 16, wherein the first packet recipient device decodes, based on the single bit indicating that the first compression scheme is in use, the first encoded packet using the first instance of the expander.

18. The computing system of claim 17, wherein the first packet recipient device:
updates the state of the second instance of the expander; and
records the update to the state of the second instance of the expander in the acknowledgement list with a positive indicator bit indicating that the first encoded packet was used to update the state of the second instance of the expander at the first packet recipient device.

19. The computing system of claim 14, wherein transmitting the first encoded packet comprises transmitting, without updating the state of the first instance of the encoder.

20. One or more non-transitory computer-readable media storing instructions that, when executed by a computing system comprising at least one processor, a communication interface, and memory, cause the computing system to:
initialize, at a packet sender device, a first instance of an encoder and a second instance of the encoder, wherein the first instance of the encoder and the second instance of the encoder are configured to encode packets for transmission to packet recipient devices;
encode, at the packet sender device and using the first instance of the encoder, a first packet;
store, at the packet sender device and using a packet reference list, a reference to the first packet;
transmit, to a first packet recipient device, the first encoded packet;
receive, from the first packet recipient device, an acknowledgement list indicating the first packet; and
based on identifying that the acknowledgement list matches the packet reference list:
update a state of the second instance of the encoder based on the packet reference list,
clear the packet reference list,
update a state of the first instance of the encoder to match a state of the second instance of the encoder, and
switch from use of the first instance of the encoder to the second instance of the encoder.
